(19) United States
(12) Patent Application Publication
(10) Pub. No.: US 2018/0137770 A1
(43) Pub. Date: May 17, 2018

(54) MUSICAL INSTRUMENT INDICATOR APPARATUS, SYSTEM, AND METHOD TO AID IN LEARNING TO PLAY MUSICAL INSTRUMENTS

(71) Applicant: Michael Kyle Whisenant, Salt Lake City, UT (US)

(72) Inventor: Michael Kyle Whisenant, Salt Lake City, UT (US)

(21) Appl. No.: 15/813,062

(22) Filed: Nov. 14, 2017

Related U.S. Application Data
(60) Provisional application No. 62/421,901, filed on Nov. 14, 2016.

(51) Int. Cl. G09B 15/00; G09B 15/02; G09B 15/04; G06F 3/01

(52) U.S. Cl. CPC G09B 15/003; G09B 15/023; G06F 3/014; G06F 3/016; G09B 15/04

(57) ABSTRACT

A musical instrument indicator apparatus for aiding at least one user in learning to play at least one musical instrument, the musical instrument indicator apparatus includes: at least one user indicator device configured for attachment to at least one component of the at least one musical instrument and further configured to indicate when the at least one component of the at least one musical instrument should be used by the at least one user; and at least one controller configured to control indication from the at least one user indicator device.

### CROSS-REFERENCE TO RELATED APPLICATIONS

This application claims the benefit of U.S. Provisional Patent Application Ser. No. 62/421,901 filed on Nov. 14, 2016, which is hereby incorporated herein by reference.

### BACKGROUND

Aspiring musicians can spend countless hours struggling learning and improving at playing various instruments. This can lead to frustration, a lack of enjoyment, and fewer hours practicing and even result in giving up on learning to play completely.

### SUMMARY

A musical instrument indicator apparatus for aiding at least one user in learning to play at least one musical instrument, the musical instrument indicator apparatus includes: at least one user indicator device configured for attachment to at least one component of the at least one musical instrument and further configured to indicate when the at least one component of the at least one musical instrument should be used by the at least one user; and at least one controller configured to control indication from the at least one user indicator device.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an exemplary embodiment of a music instrument indicator system having a computing device and at least one indicator device;

FIG. 2 is a block diagram of an exemplary embodiment of a computing device used within the music instrument indicator system shown in FIG. 1;

FIG. 3 is a block diagram of an exemplary embodiment of an indicator device used within the music instrument indicator system shown in FIG. 1;

FIG. 4A depicts an exemplary embodiment of a musical instrument indicator system for use with a drum set, including a computing device and at least one indicator device;

FIG. 4B depicts an exemplary embodiment of the musical instrument indicator system for use with a drum set of FIG. 4A once installed on a drum set;

FIG. 5A depicts an exemplary embodiment of a musical instrument indicator system for use with a piano, including a computing device and at least one indicator device;

FIG. 5B depicts an exemplary embodiment of the musical instrument indicator system for use with a piano of FIG. 5A once installed on a piano;

FIG. 6A depicts an exemplary embodiment of a musical instrument indicator system for use with a guitar, including a computing device and at least one indicator device;

FIG. 6B depicts an exemplary embodiment of the musical instrument indicator system for use with a guitar of FIG. 6A once installed on a guitar;

FIG. 7 depicts an exemplary embodiment of a musical instrument indicator system for use with an instrument where the musician cannot easily see the keys/frets/notes while playing the instrument, including a computing device and at least one indicator device;

FIG. 8A shows an exemplary embodiment of an indicator device having visual indicators similar to the single housing embodiment shown and described with reference to FIG. 7;

FIG. 8B shows an exemplary embodiment of a virtual version of an indicator device similar to the indicator device of FIG. 8A implemented on a computing device;

FIG. 9A shows an exemplary embodiment of an indicator device having visual indicators similar to the piano embodiment shown and described with reference to FIGS. 5A-5B;

FIG. 9B shows an exemplary embodiment of a virtual version of an indicator device similar to the indicator device of FIG. 9A implemented on a computing device;

FIG. 10 shows an exemplary embodiment of a virtual version of an indicator similar to the drum set embodiment of an indicator device shown and described with reference to FIG. 4A-4B implemented on a computing device;

FIG. 11 depicts a flow diagram illustrating one exemplary embodiment of a method for aiding a user in learning to play musical instruments using a lighting apparatus, system, and/or application; and

FIG. 12 depicts a flow diagram illustrating one exemplary embodiments of a method for aiding a user in learning to play musical instruments using a lighting apparatus, system, and/or application.

In accordance with common practice, the various described features are not drawn to scale but are drawn to emphasize specific features relevant to the exemplary embodiments. Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

There is a need in the art for apparatuses, systems, and methods designed to help aspiring musicians to have positive experiences while they learn to play and improve at playing various instruments to minimize frustration, increase enjoyment, and maximize efficiency during practice of musical instruments. Such apparatuses, systems, and methods are described herein. More specifically, embodiments described herein include an improved method and apparatus for playing a musical instrument as a soloist or in concert with other musicians using sound, vibration, and lights to guide the musician to play the correct notes in sequence at the selected rate. Accordingly, such apparatuses, systems, and methods allow a user to hear, feel, see, and play an instrument using a combination of visual, haptic, and audio indicators.

A musical instrument indictor apparatus, system, and/or application (such as an app or other software) can aid users in learning to play musical instruments. For example, a musical instrument indictor system could be hooked up to various elements of a drum kit and communicate with a user's mobile device via Bluetooth (or other wireless personal area network (PAN) and/or local area network (LAN) protocol/device). The user can select a song and the application controls the lighting system to show which element of the drum kit to hit at which time. In other embodiments, a musical instrument indictor system is hooked up to other instruments, such as piano, guitar, and/or trumpet and can use light to show which key, string, button, finger position, etc. to use at which time. It is understood that many other instruments could also benefit from similar lighting systems and applications. In exemplary embodiments, a single application running on a user's mobile device controls multiple instrument lighting systems for multiple instruments being used by multiple musicians.

Accordingly, embodiments described herein comprise various embodiments of a musical instrument playing apparatus which utilize sound, vibration, and multi-color illuminated lights to guide a musician to play the correct notes in sequence at a selected rate. In exemplary embodiments, the system includes software for a computing device and separate physical components, such as (1) at least one computing device such as a smartphone, tablet computer, laptop computer, personal computer, server, or other micro-computer implementing general purpose hardware and/or special purpose hardware, such as a general purpose processor (GPP) (such as microcontroller (MCU) or system on a chip (SOC)) or special purpose processor (such as a field-programmable gate array (FPGA), application-specific integrated circuit (ASIC), digital signal processor (DSP) or other integrated circuit or circuitry), or any programmable logic device; (2) at least one visual indicator device including visual indicator(s) such as Red, Green, and Blue (RGB) Light-Emitting Diode (LED) lights that provide visual indications that can be attached to or be positioned near the musical instrument being played within view of the user; (3) at least one haptic indicator device including haptic/tactile/vibratory indicator(s) (such as “vibe straps” that provide vibrations that can be attached to a person, such as around an arm, leg, hand, wrist, ankle, and/or foot or positioned within a chair/seat or on an instrument); and/or (4) combination visual/haptic indicator device including both visual indicator(s) and haptic/tactile/vibratory indicator(s) (such as “RGB LED vibe gloves” that provide both visual indications and vibrations that can be attached to a person, such as on a hand or around an arm, leg, wrist, ankle, and/or foot). While visual and/or tactile/vibratory indicators are described herein, it is understood that other type of indicators, such as audible/sound could also be used.

The at least one computing device, the at least one visual indicator device, and/or the at least one tactile feedback device can work together or individually using wireless data communication such as Bluetooth (including Bluetooth profiles using Bluetooth Low Energy (Bluetooth LE or BLE) and Bluetooth profiles using classic Bluetooth), WiFi (IEEE 802.11), cellular communication, proprietary protocols, and other types of wireless communication. While wireless communication is described, it is understood that wired communication can also be used, such as twisted pair, coaxial cable, Category cabling (such as Cat-5, Cat-5e, Cat 6, Cat 7, etc.), fiber optics, and other type of wired communication.

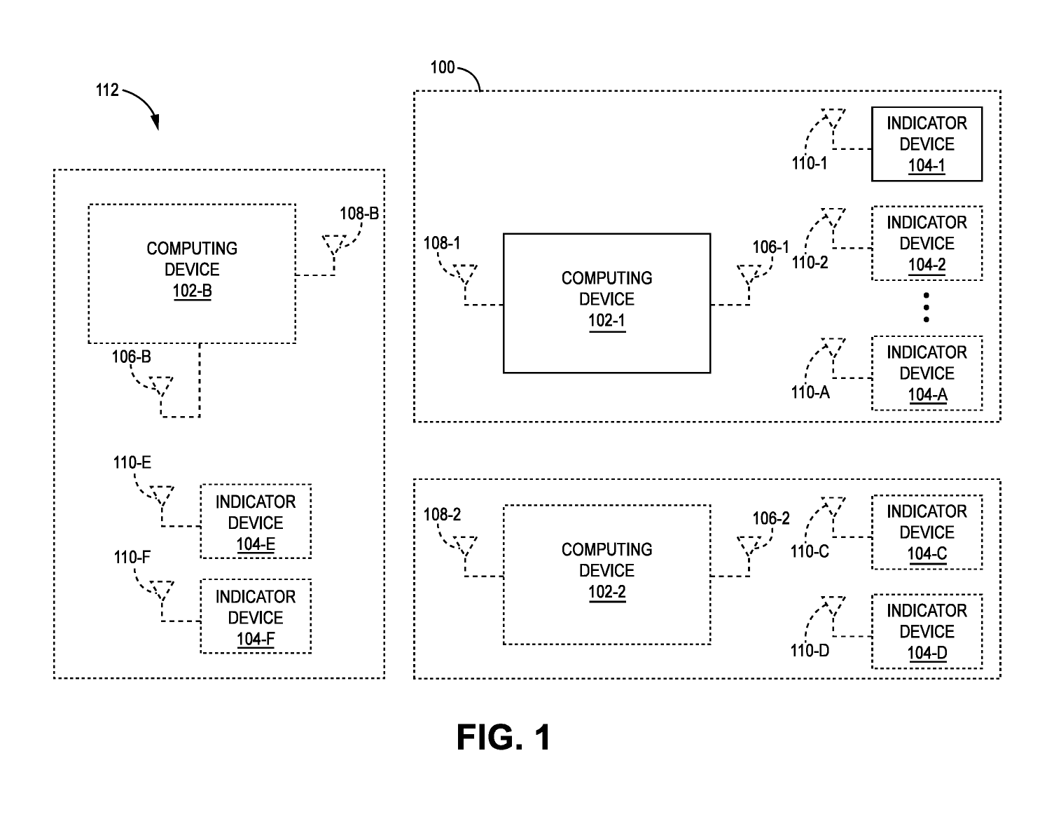

FIG. 1 is a block diagram of an exemplary embodiment of a music instrument indicator system 100 having at least one computing device 102 and at least one indicator device 104. System 100 includes a computing device 102-1 and at least one indicator device 104 (such as indicator device 104-1, optional indicator device 104-2, and any quantity of additional optional indicator devices 104 through optional indicator device 104-A). In exemplary embodiments, the computing device is communicatively coupled with the at least one indicator device 104 using wireless communication. In specific implementations using wireless communication, computing device 102-1 is coupled to or includes an antenna 106-1 and each indicator device 104 is coupled to or includes an antenna 110 (such as antenna 110-1, optional antenna 110-2, and any quantity of additional optional antenna 110 through optional antenna 110-A). In exemplary embodiments, the computing device 102-1 is communicatively coupled to one of more of the at least one indicator device 104 through cabled communication (including conductive and/or optical media). In exemplary embodiments, the indicator devices 104 include at least one of visual indicator(s), haptic indicator(s), and audio indicator(s) configured to visually, haptically, and/or audibly indicate to a user. In exemplary embodiments, the indicator devices 104 are positioned on or near musical instruments or users to aid in learning how to play musical instruments. In exemplary embodiments having more than one computing device 102, the computing devices 102 can be communicatively coupled using antennas 108 (such as antenna 108-1 and optional antenna 108-2 and optional antenna 108-B),

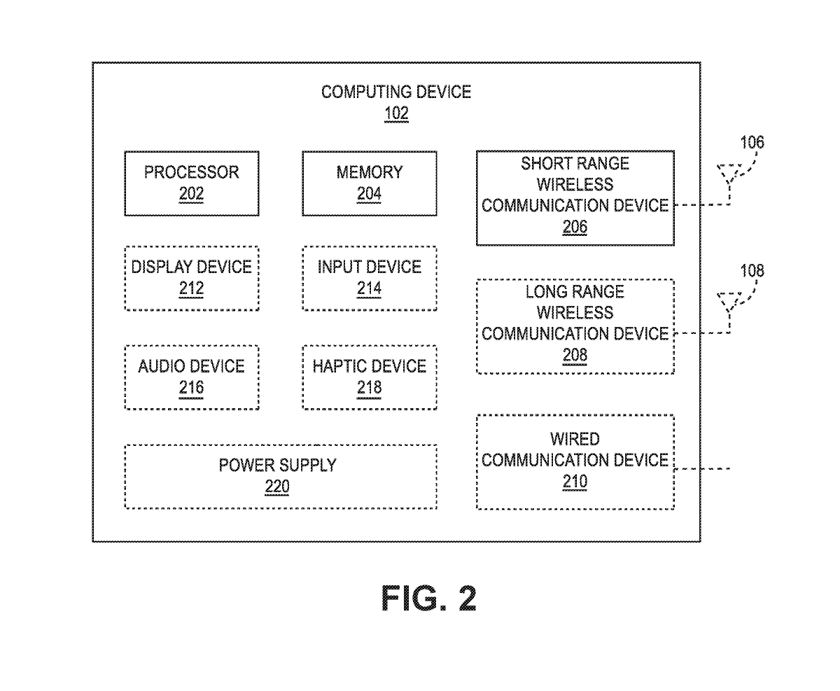

FIG. 2 is a block diagram of an exemplary embodiment of a computing device 102 used within the music instrument indicator system 100. In exemplary embodiments, the computing device includes a processor 202, memory 204, and at least one of a short range wireless communication device 206, a long range wireless communication device 208, or a wired communication device 210. In exemplary embodiments, the at least one processor 202 can be any known processor, such as a general purpose processor (GPP) or special purpose (such as a field-programmable gate array (FPGA), application-specific integrated circuit (ASIC) or other integrated circuit or circuitry), or any programmable logic device. In exemplary embodiments, the processor 202 includes circuitry necessary to interpret and execute program instructions.

In exemplary embodiments, the at least one memory 204 can be any device, mechanism, or populated data structure used for storing information. In exemplary embodiments, the at least one memory 204 can be or include any type of volatile memory, nonvolatile memory, and/or dynamic memory. For example, the at least one memory 204 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like. In accordance with some embodiments, the at least one memory 204 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as the at least one memory 204. The at least one memory 204 may be used to store instructions for running one or more applications or modules on the at least one processor 202. For example, the at least one memory 204 could be used in one or more embodiments to house all or some of the instructions needed to execute the functionality of the computing device described herein. In exemplary embodiments, the functionality of the computing device described herein is implemented by the at least one processor 202 and the at least one memory 204.

While FIG. 2 is shown with the long range wireless communication device 208 and the wired communication device 210 as being optional, it is understood that any of the communication devices can be used to communicate with the at least one indicator device 104. In exemplary embodiments, at least one short range wireless communications device 206 includes circuitry for communicating using a personal area network (PAN) to communicate with at least one indicator device 104 using Bluetooth (including Bluetooth profiles using Bluetooth Low Energy (Bluetooth LE or BLE) and Bluetooth profiles using classic Bluetooth) or another protocol. In exemplary embodiments, at least one short range wireless communications device 206 uses a wireless local are network (wireless LAN) to communicate with at least one indicator device 104 device using WiFi (IEEE 802.11) or another protocol.

In exemplary embodiments, at least one long range wireless communication device 208 includes circuitry for communicating using a wide are network (WAN), such as a cellular network (and possibly through the Internet) to communicate with at least one indicator device using 104 (or other remote device) using a radio access technology, such as Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc. In exemplary embodiments, at least one wired communication device 210 is uses a wired local area network (LAN) to communicate with at least one indicator device 104 using a wired network technology, such as Ethernet across a wired media, such as twisted pair, coaxial cable, Category cabling (such as Cat-5, Cat-5e, Cat 6, Cat 7, etc.), fiber optics, or other type of conductive or optical media, or other type of wired media.

In exemplary embodiments, the computing device 102 includes at least one optional display device 212, at least one optional input device 214, at least one optional audio device 216, at least one optional haptic device 218, and at least one optional power supply 220. In exemplary embodiments, the optional at least one display device 212 includes circuitry for displaying information. In exemplary embodiments, the optional at least one display device 212 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), and a plasma display. In exemplary embodiments, the optional at least one input device 214 includes circuitry for receiving input from a user. In exemplary embodiments, the optional at least one input device 214 includes at least one of a touchscreen (including capacitive and resistive touchscreens), a touchpad, a capacitive button, a mechanical button, a switch, a dial, a keyboard, a mouse, a camera, a biometric sensor/scanner, etc. In exemplary embodiments, the optional at least one display device 210 and the optional at least one input device 212 are combined into a human machine interface (HMI) for user interaction with the computing device 102.

In exemplary embodiments, the optional at least one audio device 216 includes circuitry for producing audio sounds. In exemplary embodiments, the optional at least one audio device 216 includes a speaker, buzzer, or other noise maker. In exemplary embodiments, the optional at least one haptic device 218 includes circuitry for producing vibrations or other movement. In exemplary embodiments, the optional at least one haptic device 218 includes a vibration motor (such as a small unbalanced electrical motor that causes vibration when activated). In exemplary embodiments, the optional power supply 220 provides power to the other components of the computing device 102 and may be a battery and/or a wired power supply that can be plugged into an outlet or other device for power.

In exemplary embodiments, the computing device 102 is configured to process digital musical note data in sequence which is used to produce control at least one indicator device 104 to produce lighting, vibration, and/or sound for various musical instruments.

In exemplary embodiments, a plurality of computing devices 102 (including computing device 102-1 and at least one of optional computing device 102-2 and optional computing device 102-B) can be combined with a plurality of indicator devices 104 for different instruments in a coordinated network 112 where one of the computing devices 102 (in this case, computing device 102-1) is configured to act as a virtual “conductor” to control and coordinate the performance of multiple computing devices 102 (including optional computing device 102-2 and optional 102-B) and referred to as “subscribers” in multiuser jam sessions. In exemplary embodiments, the “conductor” computing device 102-1 sends digital signals using a wireless network to the “subscriber” computing devices 102 which includes but is not limited to starting, stopping, modifying tempo, and changing songs. This coordinated network 112 enables multiple musicians to perform their musical part, on their instrument, in concert, to produce a single song. In exemplary embodiments, subscriber computing device 102 can connect to the conductor computing device 102-1 using any manner of wireless or wired communication, such as including but not limited to Bluetooth, Wifi, USB, Ethernet, and Internet links. The user of the conductor computing device 102-1 controls all the subscriber computing device(s) 102 to coordinate instructions sent to the indicator device(s) 104 for the various subscriber computing device(s) 102. In other exemplary embodiments, a single computing device 102 is configured to connect to indicator device(s) 104 for a plurality of instruments, such that a single computing device 102 is coordinating the indicator device(s) for the plurality of instruments. It is understood that the coordination of multiple users using different instruments with various indicator device(s) can be performed in additional ways.

In exemplary embodiments, the users with their various subscriber computing devices 102 are remotely located from the conductor computing device 102 and/or each other and the coordinated network 112 includes a wide area network (WAN), such as the Internet. In exemplary embodiments, the conductor computing device 102 and subscriber computing devices 102 can communicate using an intermediary server to coordinate a performance (either in-person or remote). In exemplary embodiments, the process of selecting, starting, stopping, and synchronizing devices is coordinated by a cloud server within the coordinated network 112. In exemplary embodiments, the conductor computing device 102 and at least some of the subscriber computing devices 102 are located near each other (such as the same room or venue). In exemplary embodiments, some of the subscriber computing devices 102 are located near each other (such as the same room or venue) while others are remotely located (such as across the city, country, or world) and connected via a wide area network (WAN) such as the Internet. An advantage of these types of embodiment is that users that are not in the same physical location can conduct jam sessions over the Internet or other networks in virtual jam sessions.

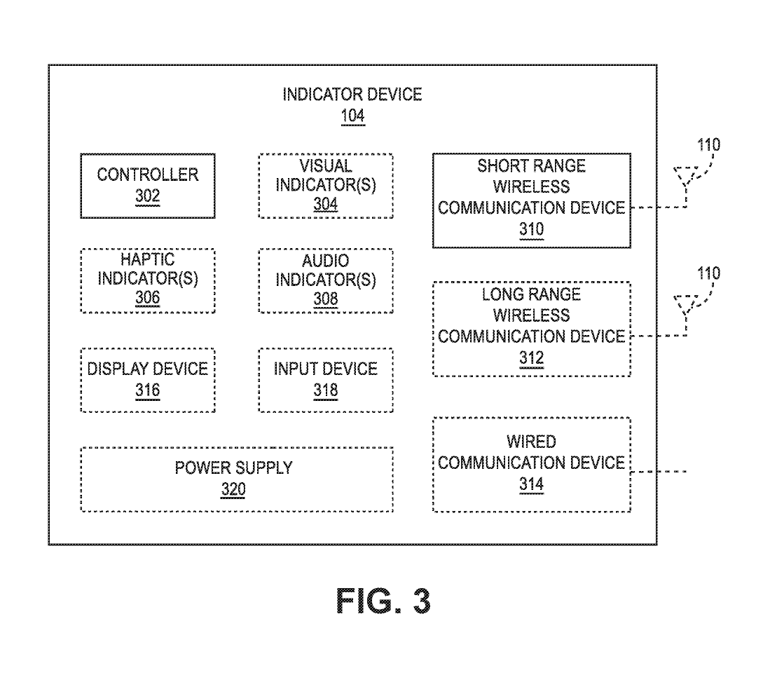

FIG. 3 is a block diagram of an exemplary embodiment of an indicator device 104 used within the music instrument indicator system 100. In exemplary embodiments, the indicator device 104 includes a controller 302 and at least one of at least one visual indicator 304, at least one haptic indicator 306, at least one audio indicator 308. In exemplary embodiments, the at least one controller 302 can be any known processor and/or memory, such as a general purpose processor (GPP) or special purpose (such as a field-programmable gate array (FPGA), application-specific integrated circuit (ASIC) or other integrated circuit or circuitry), or any programmable logic device and any device, mechanism, or populated data structure used for storing information, such as volatile memory, nonvolatile memory, and/or dynamic memory. In exemplary embodiments, the functionality of the at least one indicator device 104 described herein is implemented by the controller 302. In exemplary embodiments, the controller 302 includes circuitry necessary to interpret and execute program instructions and/or to send or receive signals with any visual indicator(s) 304, haptic indicator(s) 306, audio indicator(s) 308, and/or sensors connected to the controller 302. While FIG. 3 shows the visual indicator(s) 304, haptic indicator(s) 306, and audio indicator(s) 308 within the indicator device 104, it is understood that these may be external and connected via wired or wireless links. Exemplary embodiments include various components of the indicator device 104 housed in different housing even though the various components work together to function as a single device.

In exemplary embodiments, the at least one visual indicator 304 is implemented using at least one light emitting device selected from at least one light emitting diode (LED), at least one liquid crystal display (LCD), at least one light bulb, at least one organic light emitting diode (OLED), at least one field emission display (FED), at least one surface-conduction electron-emitter display (SED), at least one plasma display, and/or at least one laser light source. In exemplary embodiments, the at least one haptic indicator 306 is implemented using a vibration motor (such as a small unbalanced electrical motor that causes vibration when activated). In exemplary embodiments, the at least one audio indicator 308 is implemented using at least one of a speaker, a buzzer, or other noise making device.

In exemplary embodiments, an indicator device 104 contains circuitry to illuminate different colored lights based on the control signs received from the computing device. In exemplary embodiments, an indicator device 104 contains circuitry to vibrate at different times to aid the user in keeping time, tempo, and/or beat. In exemplary embodiments, an indicator device 104 can include any combination of visual indicators 304, haptic indicators 306, and audio indicators 308. In implementations where an indicator device 104 is attached to a musical instrument, the indicator device 104 may only include visual indicator(s) 304 to aid the user in seeing where to play notes (such as with “RGB LED lights”). In exemplary embodiments, where an indicator device 104 is attached to a users body (such as to an arm, leg, hand, wrist, ankle, and/or foot) or within a char/seat, the indicator may only include haptic indicator(s) 306 to aid the user in keeping time, tempo, and/or a beat (such as with “vibe straps”). In exemplary embodiments, it is desirable that both visual indicators 304 and haptic indicators 306 be used with a particular indicator device 104, such as with “RGB LED Vibe Gloves” that both light up and vibrate to enable the user to know where and when to play notes and to keep time, tempo, and/or a beat. In exemplary embodiments, headphones or other speakers can be used both to listen to music and to have additional audible or haptic indications using audio indicator(s) 308 and/or haptic indicator(s) 306. While visual, haptic/tactile/vibratory, and audible indicators are described herein, it is understood that other type of indicators could also be used.

In exemplary embodiments, the indicator device 104 includes at least one of a short range wireless communication device 310, a long range wireless communication device 312, and/or a wired communication device 314. While FIG. 3 is shown with the long range wireless communication device 312 and the wired communication device 314 as being optional, it is understood that any of the communication devices can be used to communicate with the at least one computing device 102. In exemplary embodiments, at least one short range wireless communications device 310 includes circuitry for communicating using a personal area network (PAN) to communicate with at least one computing device 102 using Bluetooth (including Bluetooth profiles using Bluetooth Low Energy (Bluetooth LE or BLE) and Bluetooth profiles using classic Bluetooth) or another protocol. In exemplary embodiments, at least one short range wireless communications device 310 uses a wireless local are network (wireless LAN) to communicate with at least one computing device 104 device using WiFi (IEEE 802.11) or another protocol.

In exemplary embodiments, at least one long range wireless communication device 312 includes circuitry for communicating using a wide are network (WAN), such as a cellular network (and possibly through the Internet) to communicate with at least one computing device using 102 (or other remote device) using a radio access technology, such as Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc. In exemplary embodiments, at least one wired communication device 314 uses a wired local area network (LAN) to communicate with at least one computing device 102 using a wired network technology, such as Ethernet across a wired media, such as twisted pair, coaxial cable, Category cabling (such as Cat-5, Cat-5e, Cat 6, Cat 7, etc.), fiber optics, or other type of conductive or optical media, or other type of wired media.

In exemplary embodiments, the indicator device 104 includes at least one optional display device 316, at least one optional input device 318, and at least one optional power supply 220. In exemplary embodiments, the optional at least one display device 316 includes circuitry for displaying information. In exemplary embodiments, the optional at least one display device 316 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), and a plasma display. In exemplary embodiments, the optional at least one input device 318 includes circuitry for receiving input from a user. In exemplary embodiments, the optional at least one input device 318 includes at least one of a touchscreen (including capacitive and resistive touchscreens), a touchpad, a capacitive button, a mechanical button, a switch, a dial, a keyboard, a mouse, a camera, a biometric sensor/scanner, etc. In exemplary embodiments, the optional at least one display device 316 and the optional at least one input device 318 are combined into a human machine interface (HMI) for user interaction with the indicator device 104. In exemplary embodiments, the optional power supply 320 provides power to the other components of the indicator device 104 and may be a battery and/or a wired power supply that can be plugged into an outlet or other device for power.

In exemplary embodiments, each indicator device 104 receives signals from the computing device 102, directing the indicator device 104 to use its visual indicator(s) 304, haptic indicator(s) 306, and/or audio indicator(s) 308 to activate in various ways. Each indicator device 104 can be configured in different ways to implement visual, haptic, and/or audio indication to users using visual indicator(s) 304, haptic indicator(s) 306, and/or audio indicator(s) 308.

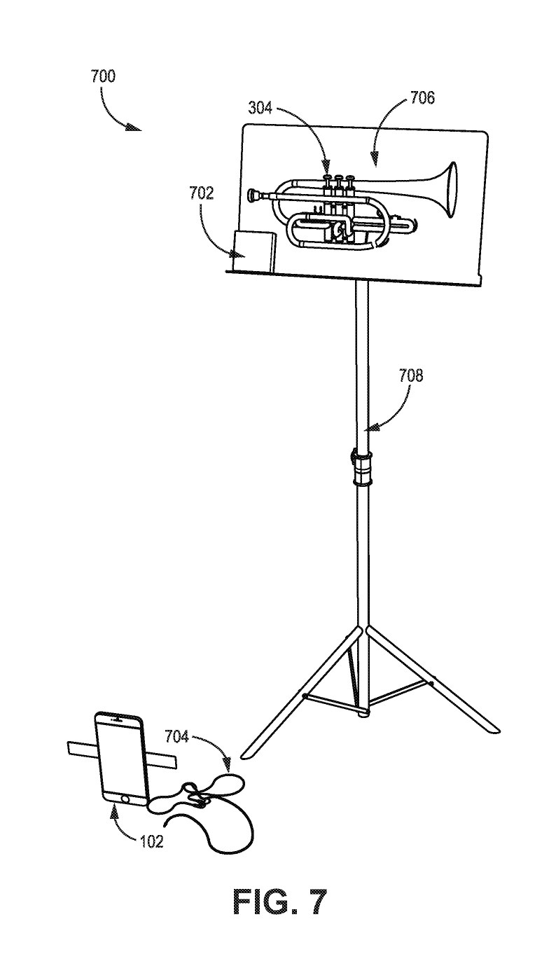

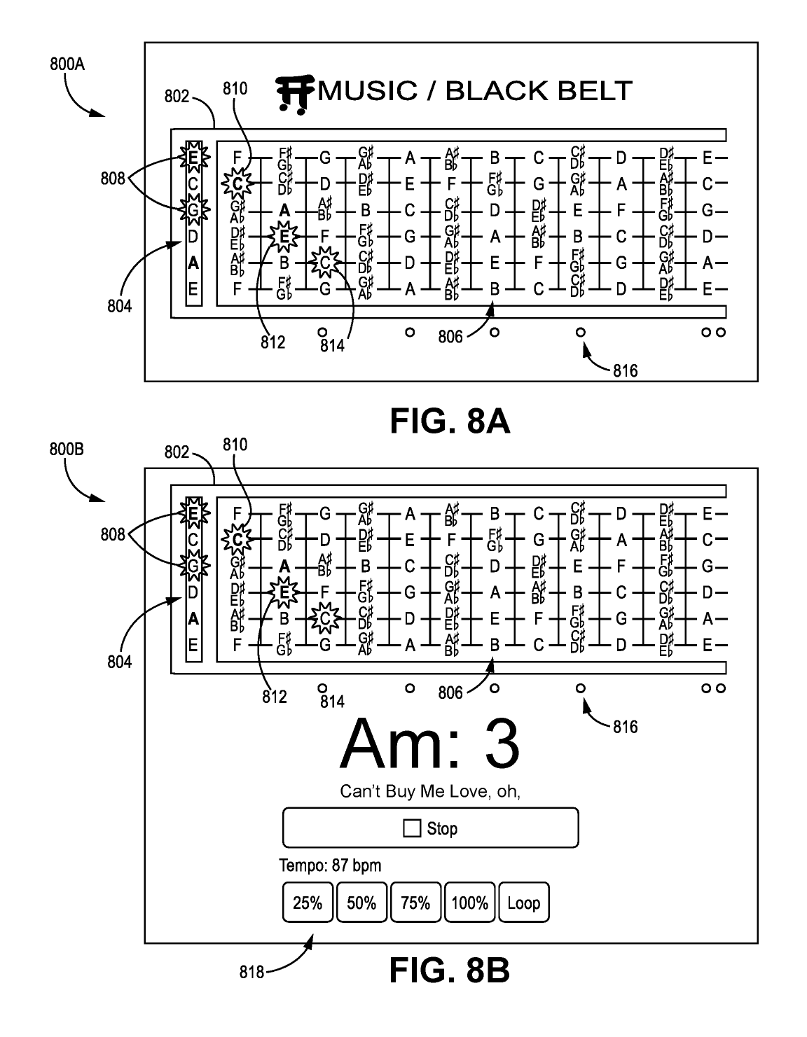

An indicator device 104 implementing visual indicator(s) 304 can include a series of addressable light emitting devices as the visual indicators 304. The indicator device 104 can turn on and off and change colors of the series of addressable light emitting devices to provide visual notification to the user of the beats and/or notes in sequence. When an indicator device 104 is implemented as a lighting system having visual indicator(s) 304, it may be attached to a musical instrument or show an illustrated representation of the musical instrument or a portion of the musical instrument with integrated lights, such as an illustrated trumpet as shown below with reference to FIG. 7 or a fretboard of a guitar as shown below with reference to FIG. 8. In exemplary embodiments, the indicator device 104 includes a housing for the controller 302 and the communication device (such as short range wireless communication device 310, long range wireless communication device 312, and/or wired communication device 314) that is separate from at least some of the indicators (the visual indicator(s) 304, haptic indicator(s) 306, and/or audio indicator(s) 308) and connected to at least some of the indicators (the visual indicator(s) 304, haptic indicator(s) 306, and/or audio indicator(s) 308) by wires (running out of the enclosure) or wireless links so that the housing can be placed in a separate position from the various indicators (particularly visual indicator(s) 304) which can be placed on the various components of the musical instruments.

An indicator device 104 implementing haptic indicator(s) 306 can produce a sequence of pulsating vibrations using mini vibra-motors (such as with a “Vibe Strap” or other specially designed external device). The system 100 may use haptic device 218 (such as a vibration motor) integrated into the computing device 102 (such as with a smartphone, smart watch or other wearable). In exemplary embodiments, the “Vibe Strap” or the computing device 102 when being used for haptic purposes is temporarily attached to one or more parts of the musician's body and can receive signals from the computing device 102 to activate haptic indicator(s) 306 such as vibration motors to create vibrating pulses as a means to notify a musician of significant beats and/or notes in sequence.

An indicator device 104 implementing both visual indicator(s) 304 and haptic indicator(s) 306 could be implemented as a specially designed pair of gloves (such as fingerless gloves) referred to as “RGB LED Vibe Gloves”. Each “RGB LED Vibe Glove” could include visual indicator(s) 304 and haptic indicator(s) 306 integrated into each finger of the glove (or other places within the glove) and can receive signals from the computing device 102 to activate the visual indicator(s) 304 (such as lights) and/or haptic indicator(s) 306 (such as vibration motors) to notify the musician of the correct notes to play in sequence.

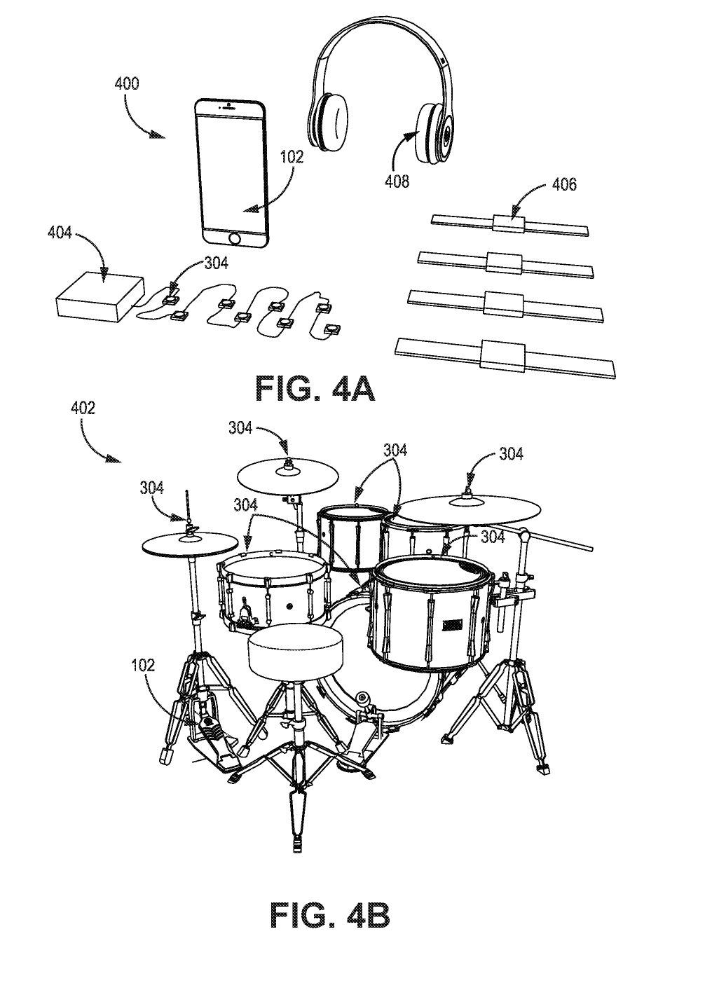

FIG. 4A depicts an exemplary embodiment of a musical instrument indicator system 400 (an implementation of system 100) for use with a drum set 402 and FIG. 4B depicts the exemplary embodiment of the musical instrument indicator system 400 for use with a drum set 402 once installed on a drum set 402. The system 400 includes a computing device 102 (embodied as a smartphone in FIG. 4A) and at least one indicator device 104 (embodied as one or more of visual indicator device 404, haptic indicator device 406, and audio indicator device 408 in FIG. 4A). In exemplary embodiments, the visual indicator device 404 includes at least one visual indicator 304 as described herein implemented using at least one light emitting device that can be attached to various components of the drum set to aid the user in knowing which component of the drum set to use. In exemplary embodiments, the visual indicator device 404 includes a plurality of visual indicators 304 connected by wire to the main housing of the indicator device 104 with appropriate length making it possible to attach each individual visual indicator 304 (such as an RGB LED light) to each individual component of the drum set 402 (such as a drum or percussion instrument). In exemplary embodiments, specially designed clips or Velcro can be used to attach each visual indicator 304 (such as an RGB LED light) to the different parts of the drum set, such as a drum, cymbal, pedal, or other component.

In exemplary embodiments, the haptic indicator device 406 includes at least one haptic indicator 306 as described herein that can be attached to a user to help the user keep time, tempo, and/or a beat (such as a “vibe-strap”). In exemplary embodiments, the audio indicator device 408 is implemented in headphones which provide audio indications to the user to help the user keep time, tempo, and/or a beat. In exemplary embodiments, music is output through the audio indicator device 408 that is synchronized in time with visual and/or haptic indicators provided by the visual indicator device 404 and/or haptic indicator device 406. The combination of input from various visual indicator device(s) 404, haptic indicator device(s) 406 and/or audio indicator device(s) 408 enable the user to more quickly learn and improve at the drums.

In exemplary embodiments, the computing device 102 establishes wireless connection to the visual indicator device 404, the haptic indicator device(s) 406, and the audio indicator device 408. In exemplary embodiments, the user can then select the audio tracks, set the tempo, strap on the haptic indicator device(s) 406 (such as “vibe-straps” onto their ankles and wrists), if necessary, puts on the audio indicator device(s) 408 (such as headphones onto their head) and starts the song. The musical instrument indicator system 400 then plays the selected audio track at the selected tempo, vibrates the appropriate haptic indicator device(s) 406 to indicate which limb to use, and illuminates the visual indicator device 404 to show which component of the drum set to play in sequence. In exemplary embodiments, the indicator device 104 includes a housing for the controller 302 and the communication device (such as short range wireless communication device 310, long range wireless communication device 312, and/or wired communication device 314) that is separate from at least some of the indicators (the visual indicator(s) 304, haptic indicator(s) 306, and/or audio indicator(s) 308 so that the housing can be placed on the ground while the various indicators (particularly visual indicator(s) 304 for the drum set 402) can be placed on the various components for the drum set 402.

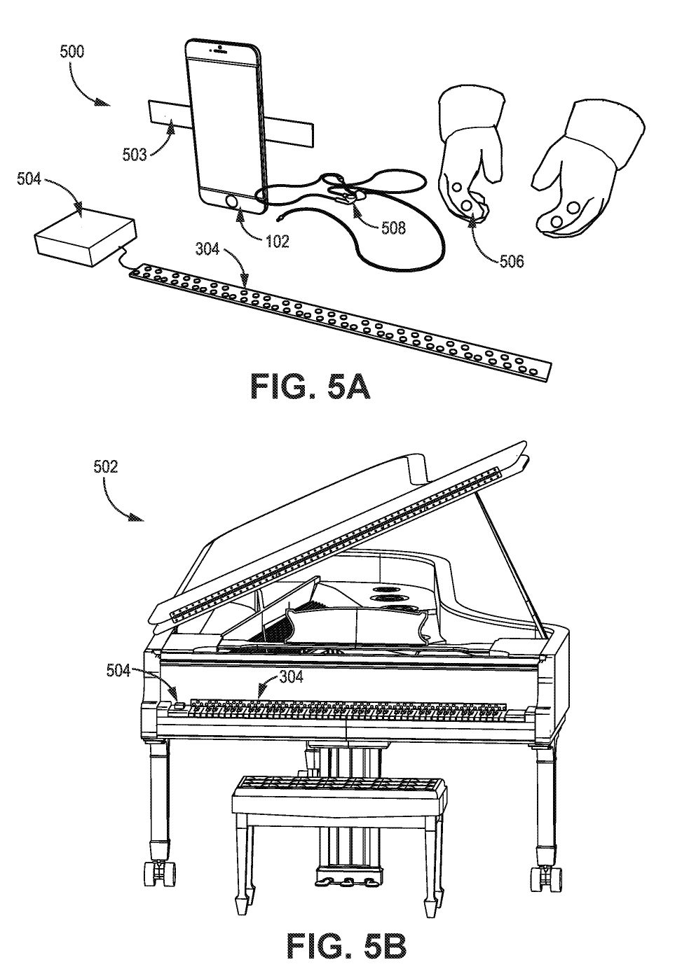

FIG. 5A depicts an exemplary embodiment of a musical instrument indicator system 500 (as an implementation of system 100) for use with a piano 502 and FIG. 5B depicts the exemplary embodiment of the musical instrument indicator system 500 for use with a piano 502 once installed on a piano 502. The system 500 includes a computing device 102 (embodied as a smartphone in FIG. 5A that can be strapped to the user's arm with a temporary fastening device, such as Velcro 503 or can be placed on the piano, such as on the music stand so the user can see the chords, lyrics, count, etc. displayed on the screen of the computing device 102) and at least one indicator device 104 (embodied as one or more of visual indicator device 504, haptic indicator device 506, and audio indicator device 508 in FIG. 5A). In exemplary embodiments, the visual indicator device 504 includes at least one visual indicator 304 as described herein implemented using at least one light emitting device that can be attached behind the keys of the keyboard of the piano 502 to aid the user in knowing which key of the piano to play. In exemplary embodiments, the set of visual indicator(s) 304 are integrated into a thin piece of plastic (connected by wires to a main housing of the indicator device 104 and referred to as the “RGB LED Panel”) which is placed at the end of the keyboard for the piano 502 and slid behind the keys of the piano 502 such that each visual indicator 304 is aligned with an individual key on the keyboard of the piano 502.

In exemplary embodiments, the haptic indicator device 506 includes at least one haptic indicator 306 as described herein that can be attached to a user to help the user identify which finger to use and/or to keep time, tempo, and/or a beat (smartphone itself with vibratory motors or a “vibe-strap”). In exemplary embodiments, the haptic indicator device 406 is a hybrid visual/haptic indicator device that includes visual indicator(s) 304 in addition to the haptic indicator(s) 306 (such as “RGB LED Vibe Gloves”) which allows for visual color coded indication and vibration on hands and/or fingers of the user that correspond to visual color coded indications above the keys of the piano 502. In exemplary embodiments, the audio indicator device 508 is implemented in headphones which provide audio indications to the user to help the user keep time, tempo, and/or a beat. In exemplary embodiments, music is output through the audio indicator device 508 that is synchronized in time with visual and/or haptic indicators provided by the visual indicator device 504 and/or haptic (or hybrid visual/haptic) indicator device 506. The combination of input from various visual indicator device(s) 504, haptic (or hybrid visual/haptic) indicator device(s) 506 and/or audio indicator device(s) 508 enable the user to more quickly learn and improve at the piano.

In exemplary embodiments, the computing device 102 establishes wireless connection to the visual indicator device 504, the haptic (or hybrid visual/haptic) indicator device(s) 506, and the audio indicator device 508. In exemplary embodiments, the user can then select the audio tracks, set the tempo, strap on the haptic indicator device(s) 506 (such as the smart phone itself or the “vibe-straps” onto an arm), if necessary, puts on the audio indicator device(s) 508 (such as headphones onto their head) and starts the song. The musical instrument indicator system 500 then plays the selected audio track at the selected tempo, vibrates the appropriate haptic indicator device(s) 506 to indicate the downbeat, illuminates and/or vibrates the individual fingers of “vibe-gloves” and illuminates the lights of the visual indicator device 504 for the various keys of piano 502 to show the correct key to play in sequence. In exemplary embodiments, the indicator device 104 includes a housing for the controller 302 and the communication device (such as short range wireless communication device 310, long range wireless communication device 312, and/or wired communication device 314) that is separate from at least some of the indicators (the visual indicator(s) 304, haptic indicator(s) 306, and/or audio indicator(s) 308 so that the housing can be placed on another portion of the piano (such as one end of the keyboard) while the various indicators (particularly visual indicator(s) 304 for the piano 502) can be placed behind the keyboard to align with the individual keys of the keyboard of the piano 502.

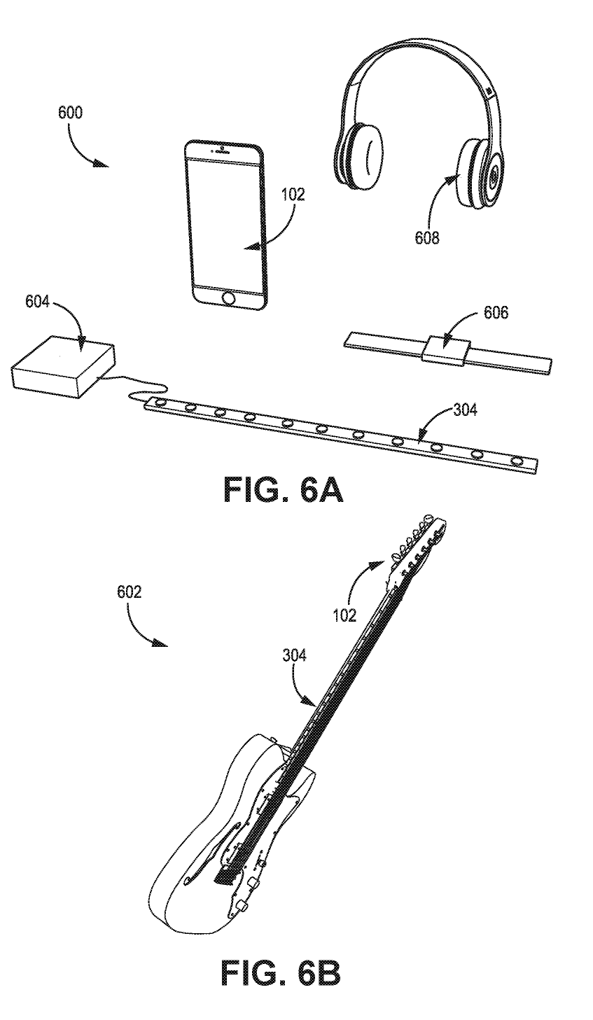

FIG. 6A depicts an exemplary embodiment of a musical instrument indicator system 600 (as an implementation of system 100) for use with a guitar 602 and FIG. 6B depicts the exemplary embodiment of the musical instrument indicator system 600 for use with a guitar 602 once installed on a guitar 602. While system 600 is discussed in the context of a guitar it would also work with a bass guitar and other stringed instruments. The system 600 includes a computing device 102 (embodied as a smartphone in FIG. 6A) and at least one indicator device 104 (embodied as one or more of visual indicator device 604, haptic indicator device 606, and audio indicator device 608 in FIG. 6A). In exemplary embodiments, the visual indicator device 604 includes at least one visual indicator 304 as described herein implemented using at least one light emitting device that can be attached on top of or adjacent to the fretboard of the guitar 602 to aid the user in knowing on which fret and/or string to position fingers and which string of the guitar 602 to play. In exemplary embodiments, the set of visual indicator(s) 304 is integrated into a thin piece of plastic (referred to as the “RGB LED Panel”) that can be attached to the top of the fretboard (such as with specially designed clips or Velcro 703) such that each visual indicator 304 is aligned with frets and/or strings of the guitar 602 but does not interfere with the function of the guitar 602. In exemplary embodiments, each visual indicator 304 is aligned with an individual opening between the frets on the fretboard of the guitar 602.

In exemplary embodiments, the haptic indicator device 406 includes at least one haptic indicator 306 as described herein that can be attached to a user to help the user identify which finger to use and/or to keep time, tempo, and/or a beat (a “vibe-strap”). In exemplary embodiments, the haptic indicator device 406 is a hybrid visual/haptic indicator device that includes visual indicator(s) 304 in addition to the haptic indicator(s) 306 (such as “RGB LED Vibe Gloves”) which allows for visual color coded indication and vibration on fingers of the user that correspond to visual color coded indications on or near the fretboard of the guitar 602. In exemplary embodiments, the audio indicator device 608 is implemented in headphones which provide audio indications to the user to help the user keep time, tempo, and/or a beat. In exemplary embodiments, music is output through the audio indicator device 608 that is synchronized in time with visual and/or haptic indicators provided by the visual indicator device 604 and/or haptic (or hybrid visual/haptic) indicator device 606. The combination of input from various visual indicator device(s) 604, haptic (or hybrid visual/haptic) indicator device(s) 606 and/or audio indicator device(s) 608 enable the user to more quickly learn and improve at the guitar.

In exemplary embodiments, the computing device 102 establishes wireless connection to the visual indicator device 604, the haptic (or hybrid visual/haptic) indicator device(s) 606, and the audio indicator device 608. In exemplary embodiments, the user can then select the audio tracks, set the tempo, strap on the haptic indicator device(s) 606 (such as “vibe-straps” onto an arm), if necessary, puts on the audio indicator device(s) 608 (such as headphones onto their head) and starts the song. The musical instrument indicator system 600 then plays the selected audio track at the selected tempo, vibrates the appropriate haptic indicator device(s) 606 to indicate when strings should be played and/or when to change finger positioning on the fretboard, illuminates and/or vibrates the individual fingers of “vibe-gloves” and illuminates the lights of the visual indicator device 604 for the various areas of the fretboard of guitar 602 to show the correct finger position in sequence. In exemplary embodiments, the indicator device 104 includes a housing for the controller 302 and the communication device (such as short range wireless communication device 310, long range wireless communication device 312, and/or wired communication device 314) that is separate from at least some of the indicators (the visual indicator(s) 304, haptic indicator(s) 306, and/or audio indicator(s) 308 so that the housing can be attached to a convenient location on the guitar 602 while the various indicators (particularly visual indicator(s) 304 for the guitar 602) can be placed on or adjacent to the fretboard of the guitar 602.

FIG. 7 depicts an exemplary embodiment of a musical instrument indicator system 700 (as an implementation of system 100) for use with an instrument where the musician cannot easily see the keys/frets/notes while playing the instrument, such as with a trumpet, saxophone, flute, or other keyed instrument (such as woodwind and brass instruments), some instances of stringed instruments (violin, viola, even a guitar, such as guitar 602), or other instruments where it is not possible or practical to see keys and/or finger position while playing. The system 700 includes a computing device 102 (embodied as a smartphone in FIG. 7 that can be attached to a user's arm, placed on a music stand, etc.) and at least one indicator device 104 (embodied as one or more of visual indicator device 702, haptic indicator device (such as computing device 102 with vibratory motors or a “vibe-strap” as described herein), and audio indicator device 704 in FIG. 5A). In exemplary embodiments, the visual indicator device 702 includes (either in the same housing or separately attached) at least one representation of the instrument or component of the instrument 706 (shown as a representation of trumpet with keys) includes at least one visual indicator 304 (such as lights positioned on the keys) as described herein implemented using at least one light emitting device that can be placed in view of the user to aid the user in knowing which key/fret/notes to position their finger on and/or play. In exemplary embodiments, the set of visual indicator(s) 304 are embodied in a single housing having an illustration of the instrument or a portion of the instrument (such buttons on a trumpet or a fretboard) that can be positioned within the user's view, such as on a music stand 708.

In exemplary embodiments, the haptic indicator device (such as computing device 102 with vibratory motors or a “vibe-strap” as described herein) includes at least one haptic indicator 306 as described herein that can be attached to a user to help the user identify which finger to use and/or to keep time, tempo, and/or a beat. In exemplary embodiments, the audio indicator device 704 is implemented in headphones which provide audio indications to the user to help the user keep time, tempo, and/or a beat. In exemplary embodiments, music is output through the audio indicator device 704 that is synchronized in time with visual and/or haptic indicators provided by the visual indicator device 702 and/or haptic indicator device (such as computing device 102 with vibratory motors or a “vibe-strap” as described herein). The combination of input from various visual indicator device(s) 702, haptic indicator device(s) (such as computing device 102 with vibratory motors or a “vibe-strap” as described herein) and/or audio indicator device(s) 704 enable the user to more quickly learn and improve at the instrument they are attempting to learn.

In exemplary embodiments, the computing device 102 establishes wireless connection to the visual indicator device 702, a haptic (or hybrid visual/haptic) indicator device(s) (such as the computing device 102 itself with vibratory motors or one or more “vibe-straps”), and the audio indicator device 704. In exemplary embodiments, the user can then select the audio tracks, set the tempo, strap on the haptic indicator device(s) (such as computing device 102 with vibratory motors or o “vibe-strap” onto an arm), if necessary, puts on the audio indicator device(s) 704 (such as headphones onto their head) and starts the song. The musical instrument indicator system 700 then plays the selected audio track at the selected tempo, vibrates the appropriate haptic indicator device(s) (such as computing device 102 with vibratory motors or a “vibe-strap” as described herein) to indicate the downbeat, and illuminates the lights of the visual indicator device 702 for the various keys/frets/notes of the instrument (such as a trumpet as shown n FIG. 7) to show the correct keys/frets/notes to position fingers at and/or play in sequence. In exemplary embodiments, the indicator device 104 includes a housing for the controller 302 and the communication device (such as short range wireless communication device 310, long range wireless communication device 312, and/or wired communication device 314) that is separate from at least some of the indicators (the visual indicator(s) 304, haptic indicator(s) 306, and/or audio indicator(s) 308 so that the housing can be placed in a different location than the various indicators (particularly visual indicator(s) 304 for the piano 502).

FIG. 8A shows an exemplary embodiment of indicator device 800A (implementing indicator device 104) having visual indicators 304 similar to the single housing embodiment shown and described with reference to FIG. 7 above. Specifically, indicator device 800A includes a set of visual indicator(s) 304 embodied in a single housing having an illustration of the instrument or a portion of the instrument (in this case a fretboard) that can be positioned within the user's view. FIG. 8B shows an exemplary embodiment of a virtual version of an indicator device 800B similar to the indicator device 800A implemented on a computing device, such as computing device 102. The virtual version of the indicator device 800B can be used instead of or in addition to physical indicator devices 104.

Both indicator device 800A and virtual indicator device 800B include a representation of a fretboard 802 of a guitar, though embodiments can show representations of other instruments or components of instruments, such as the keys on a trumpet or any other component of an instrument on another musical device. The indicator device 800A and the virtual indicator device 800B include a plurality of rows 804 representing the strings on the representation of the fretboard 802 of a guitar and a plurality of columns 806 representing the frets on the representation of the fretboard 802 of the guitar. At the intersection of each row 804 and column 806 is an indication of a note with a visual indicator 304 identifying when a particular string is played at a particular fret. In exemplary embodiments, visual indicators at 808 (implementation of visual indicator 304) are illuminated a particular color (such as red) when a string should be played without any fingers depressing on the fretboard. Similarly, indicator 810 (implementation of visual indicator 304) is illuminated a different color (such as green) when a string should be played with a finger depressing it at the particular position on the fretboard. Similarly, indicator 812 (implementation of visual indicator 304) is illuminated a different color (such as blue) when a string should be played with a finger depressing it at the particular position on the fretboard. Similarly, indicator 814 (implementation of visual indicator 304) is illuminated a different color (such as yellow) when a string should be played with a finger depressing it at the particular position on the fretboard. While different colors are described, it is understood that in other embodiments, the indicators may light up using the same color. In exemplary embodiments, the color chosen corresponds to the string being played. In exemplary embodiments, the color chosen corresponds to the finger to be used. In exemplary embodiments, coloring can match coloring on gloves worn by the user to more easily know which finger to depress which string at which fret with. In exemplary embodiments, dots 816 are included along the bottom of the representation of the fretboard 802 to represent the markers on a guitar fretboard. In exemplary embodiments, additional information and/or options 818 is available in the virtual indicator device 800B for user information and interaction.

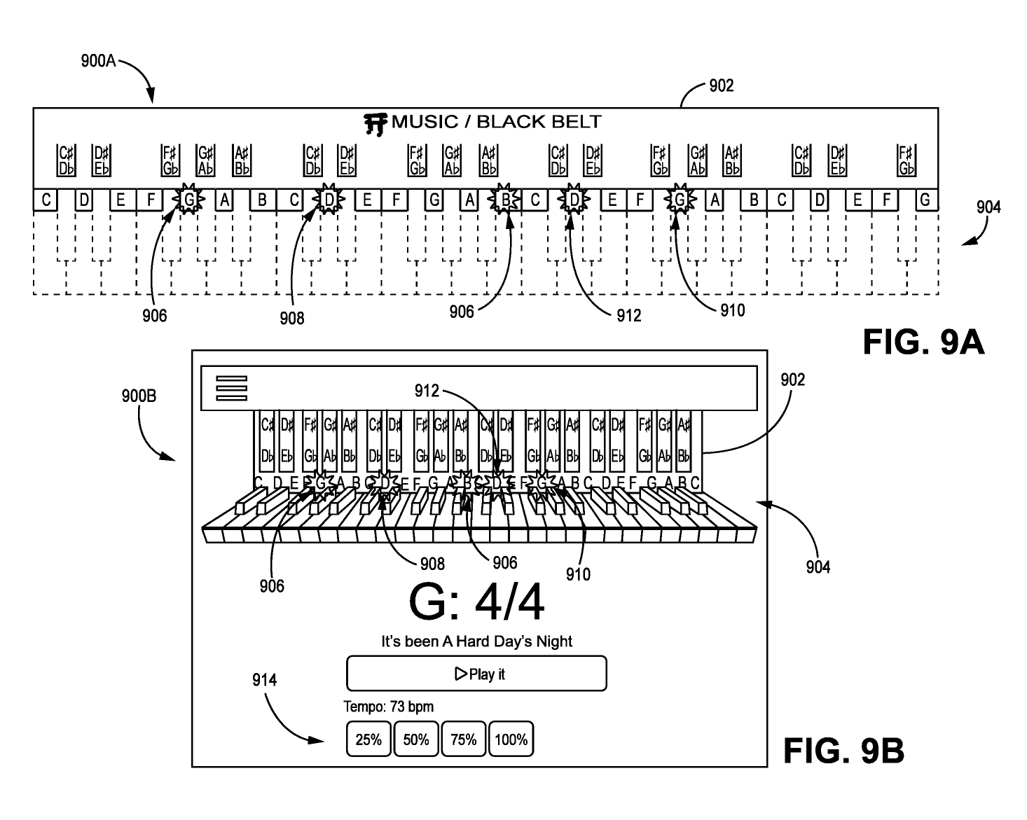

FIG. 9A shows an exemplary embodiment of an indicator device 900A (implementing indicator device 104) having visual indicators 304 similar to the piano embodiment shown and described with reference to FIGS. 5A-5B. Specifically, indicator device 900A includes a set of visual indicator(s) 304 embodied in a thin piece of plastic or other material connected by wires or wirelessly to a main housing of the indicator device 104 and referred to as a keyboard panel which is placed at the end of the keyboard for the piano 502 and slid behind the keys of the piano 502 such that each visual indicator 304 is aligned with an individual key on the keyboard of the piano 502. FIG. 9B shows an exemplary embodiment of a virtual version of an indicator device 900B similar to the indicator device 900A implemented on a computing device, such as computing device 102. The virtual version of the indicator device 900B can be used instead of or in addition to physical indicator devices 104.

Both indicator device 900A and virtual indicator device 900B include a representation of keys 902 positioned above keys 904 on a piano. The representation of keys 902 includes a plurality of visual indicators 304 positioned at each representation of a key 902. In exemplary embodiments, visual indicators at 906 (implementation of visual indicator 304) are illuminated a particular color (such as red) when a particular key or keys should be played. Similarly, indicator 908 (implementation of visual indicator 304) is illuminated a different color (such as yellow) when a particular key or keys should be played. Similarly, indicator 910 (implementation of visual indicator 304) is illuminated a different color (such as white) when a particular key or keys should be played. Similarly, indicator 912 (implementation of visual indicator 304) is illuminated a different color (such as green) when a particular key or keys should be played. While different colors are described, it is understood that in other embodiments, the indicators may light up using the same color. In exemplary embodiments, the color chosen corresponds to the finger to be used. In exemplary embodiments, coloring can match coloring on gloves worn by the user to more easily know which finger to play which key with. In exemplary embodiments, additional information and/or options 914 is available in the virtual indicator device 900B for user information and interaction.

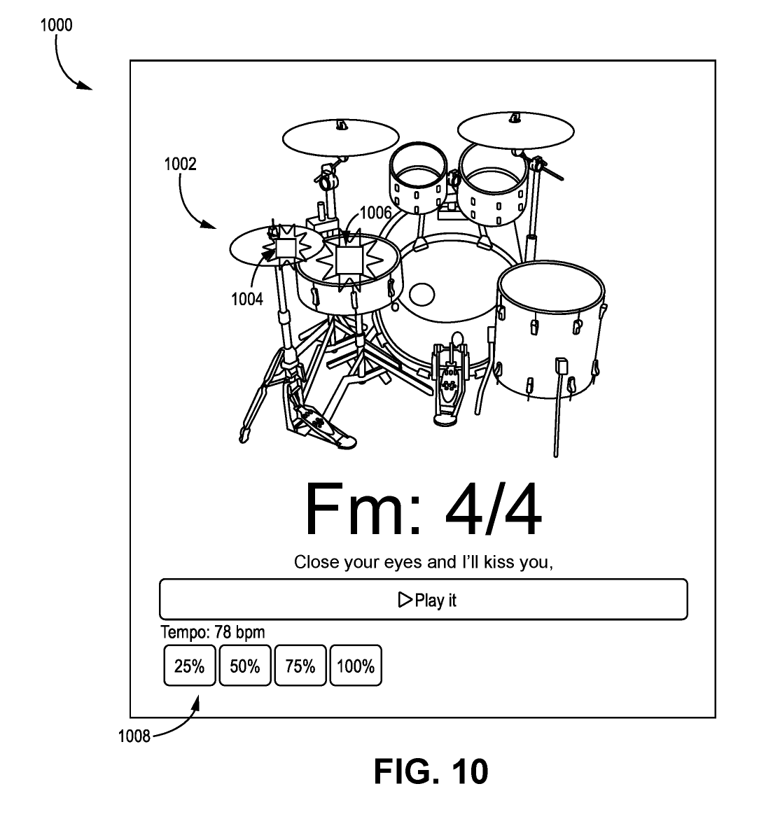

FIG. 10 shows an exemplary embodiment of a virtual version of an indicator 1000 similar to the drum set embodiment of an indicator device shown and described with reference to FIG. 4A-4B implemented on a computing device, such as computing device 102. The virtual version of the indicator device 1000 can be used instead of or in addition to physical indicator devices 104. The virtual indicator device 1000 includes a representation of the components of the drum set 1002 that can be placed within view of the user. The representation of components of the drum set 1002 include a plurality of visual indicators 304 positioned at various components of a drum set. In exemplary embodiments, a visual indicator 1004 (implementation of visual indicator 304) is illuminated a particular color (such as red) when a particular component of the drum (such as the cymbal shown in FIG. 10) should be played. Similarly, visual indicator 1006 (implementation of visual indicator 304) is illuminated a different color (such as green) when a different particular component of the drum set (such as the drum shown in FIG. 10) should be played. While different colors are described, it is understood that in other embodiments, the indicators may light up using the same color. In exemplary embodiments, the color chosen corresponds to the hand or foot to be used. In exemplary embodiments, coloring can match coloring on gloves, straps, or other indicators worn by the user to more easily know which hand of foot to play which component of the drum set with. In exemplary embodiments, additional information and/or options 1008 is available in the virtual indicator device 1000 for user information and interaction.

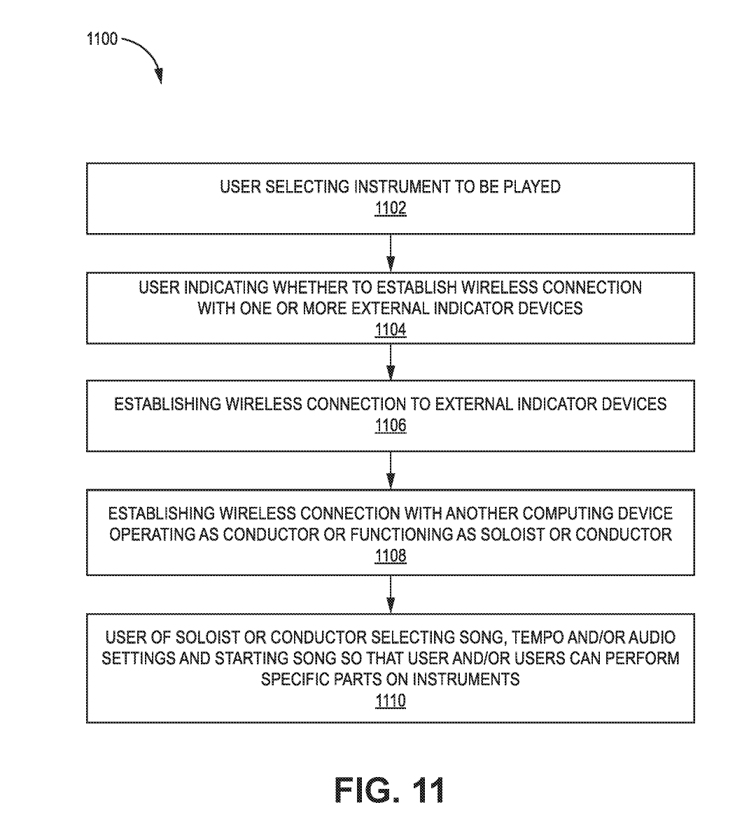

FIG. 11 depicts a flowchart of a method 1100 for user interaction with the system 100. The method begins at 1102 with the user selecting the instrument they are going to play. The method proceeds to block 1104 with the user indicating whether to establish a wireless connection with one or more external indicator devices 104. The method proceeds to block 1106 with establishing a wireless connection to the external indicator devices. The method proceeds to block 1108 with establishing a wireless connection with another computing device 102 operating as a “conductor” or functioning as a soloist or a “conductor” allowing other computing devices 102 to establish a wireless connection to the computing device 102. The method proceeds at block 1110 with a user of the soloist or conductor selecting a song, tempo, and/or audio settings and starting a song so that the user and/or users can perform their specific parts on their specific instruments based on the audio, vibration, and lights unique to their musical part in the song

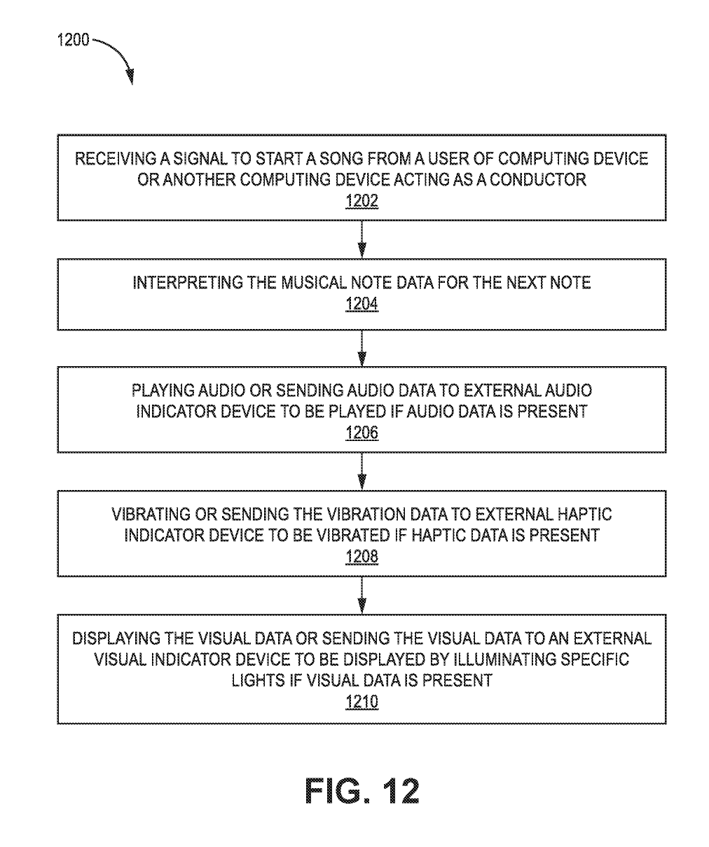

FIG. 12 depicts a flowchart of a method 1200 for operation of the system 100 during performance of a song. The method 1200 begins at 1202 with the computing device 102 receiving a signal to start a song from a user of the computing device 102 or another computing device acting as a “conductor”. The method 1200 proceeds to block 1204 with interpreting the musical note data for the next note. If audio data is present, the computing device proceeds to block 1206 with playing the audio or sending the audio data to an external audio indicator device to be played. If haptic data is present, the computing device proceeds to block 1208 with vibrating or sending the vibration data to an external haptic indicator device to be vibrated. If visual data is present, the computing device proceeds to block 1210 with displaying the visual data or sending the visual data to an external visual indicator device to be displayed by illuminating specified lights. This processing is repeated until the method ends once the last note is processed and the song ends.

Any of the units, devices, processors, etc. described herein may implement at least some of the processing described herein. In exemplary embodiments, any of the units, devices, processors, etc. described herein include circuitry and/or a programmable processor, such as a microcontroller, an application-specific integrated circuit (ASIC), a field-programmable gate array (FPGA), a field-programmable object array (FPOA), or a programmable logic device (PLD). The units, devices, processors, etc. described herein may include or function with software programs, firmware or other computer readable instructions for carrying out various methods, process tasks, calculations, and control functions, described herein. These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAIVIBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

### Example Embodiments

Example 1 includes a musical instrument indicator apparatus for aiding at least one user in learning to play at least one musical instrument, the musical instrument indicator apparatus comprising: at least one user indicator device configured for attachment to at least one component of the at least one musical instrument and further configured to indicate when the at least one component of the at least one musical instrument should be used by the at least one user; and at least one controller configured to control indication from the at least one user indicator device.

Example 2 includes the musical instrument indicator apparatus of Example 1, wherein the at least one controller is configured to receive input from an external computing device and to control the indication from the at least one user indicator device based on the input from the external computing device.

Example 3 includes the musical instrument indicator apparatus of Example 2, wherein the external computing device is at least one of a mobile phone (including smart phones and feature phones), a tablet computer, a laptop computer, a desktop computer, an all-in-one computer, a personal data assistant, or an application device.

Example 4 includes the musical instrument indicator apparatus of any of Examples 1-3, wherein the at least one user indicator device includes: at least one visual indicator configured to visually indicate when the at least one component of the at least one musical instrument should be used by the at least one user.

Example 5 includes the musical instrument indicator apparatus of Example 4, wherein the at least one visual indicator includes at least one of at least one light emitting diode (LED), at least one liquid crystal display (LCD), at least one light bulb, at least one light emitting diode (LED), at least one organic light emitting diode (OLED), at least one field emission display (FED), at least one surface-conduction electron-emitter display (SED), at least one plasma display, or at least one laser light source.

Example 6 includes the musical instrument indicator apparatus of any of Examples 1-5, wherein the at least one user indicator device includes: at least one haptic indicator configured to provide haptic indications to the at least one user when the at least one component of the at least one musical instrument should be used by the at least one user.

Example 7 includes the musical instrument indicator apparatus of any of Examples 1-6, wherein the at least one user indicator device includes: two separate user indicator devices configured for attachment with two different musical instruments.

Example 8 includes the musical instrument indicator apparatus of any of Examples 1-7, further configured to interface and communicate with at least a second musical instrument indicator apparatus having at least another user indicator device configured to be worn by the at least one user.

Example 9 includes the musical instrument indicator apparatus of Example 8, wherein the at least the second musical instrument indicator apparatus is integrated into at least one of at least one glove or at least one strap configured to be worn by the at least one user.

Example 10 includes the musical instrument indicator apparatus of any of Examples 8-9, wherein the at least the second user indicator device includes at least one of: at least one visual indicator configured to visually indicate when the at least one component of the at least one musical instrument should be used by the at least one user; at least one haptic indicator configured to provide haptic indications to the at least one user when the at least one component of the at least one musical instrument should be used by the at least one user; and at least one audible indicator configured to provide audible indications to the at least one user when the at least one component of the at least one musical instrument should be used by the at least one user.

Example 11 includes a system for aiding at least one user in learning to play at least one musical instrument, the system comprising: at least one computing device having a processor and memory; and at least one musical instrument indicator apparatus for aiding at least one user in learning to play at least one musical instrument, the musical instrument indicator communicatively coupled to the at least one computing device, the musical instrument indicator apparatus comprising: at least one user indicator device configured for attachment to at least one component of the at least one musical instrument and further configured to indicate when the at least one component of the at least one musical instrument should be used by the at least one user; and at least one controller configured to control indication from the at least one user indicator device based on input received from the at least the first computing device.

Example 12 includes the system of Example 11, wherein the at least one computing device is at least one of a mobile phone (including smart phones and feature phones), a tablet computer, a laptop computer, a desktop computer, an all-in-one computer, a personal data assistant, or an application device.

Example 13 includes the system of any of Examples 11-12, wherein the at least one user indicator device includes: at least one visual indicator configured to visually indicate when the at least one component of the at least one musical instrument should be used by the at least one user.

Example 14 includes the system of Example 13, wherein the at least one visual indicator includes at least one of at least one light emitting diode (LED), at least one liquid crystal display (LCD), at least one light bulb, at least one light emitting diode (LED), at least one organic light emitting diode (OLED), at least one field emission display (FED), at least one surface-conduction electron-emitter display (SED), at least one plasma display, or at least one laser light source.

Example 15 includes the system of any of Examples 11-14, wherein the at least one user indicator device includes: at least one haptic indicator configured to provide haptic indications to the at least one user when the at least one component of the at least one musical instrument should be used by the at least one user.

Example 16 includes the system of any of Examples 11-15, wherein the at least one user indicator device includes: two separate user indicator devices configured for attachment with two different musical instruments.

Example 17 includes the system of any of Examples 11-16, further configured to interface and communicate with at least a second musical instrument indicator apparatus having at least another user indicator device configured to be worn by the at least one user.

Example 18 includes the system of Example 17, wherein the at least the second musical instrument indicator apparatus is integrated into at least one of at least one glove or at least one strap configured to be worn by the at least one user.

Example 19 includes the system of any of Examples 17-18, wherein the at least the second user indicator device includes at least one of: at least one visual indicator configured to visually indicate when the at least one component of the at least one musical instrument should be used by the at least one user; at least one haptic indicator configured to provide haptic indications to the at least one user when the at least one component of the at least one musical instrument should be used by the at least one user; and at least one audible indicator configured to provide audible indications to the at least one user when the at least one component of the at least one musical instrument should be used by the at least one user.

Example 20 includes a system for aiding a plurality of users in learning to play musical instruments, the system comprising: a first computing device; at least a first musical instrument indicator apparatus communicatively coupled to the first computing device, the at least the first musical instrument indicator apparatus comprising: at least a first user indicator device configured for attachment to at least a first component of a first musical instrument and further configured to indicate when the at least the first component of the first musical instrument should be used by a first user; and at least a first controller configured to control indication from the at least the first user indicator device based on first input received from the first computing device; at least a second computing device communicatively coupled to the first computing device; and at least a second musical instrument indicator apparatus communicatively coupled to the at least the second computing device, the at least the second musical instrument indicator apparatus comprising: at least a second user indicator device configured for attachment to at least a second component of a second musical instrument and further configured to indicate when the at least the second component of the second musical instrument should be used by a second user; and at least a second configured to control indication from the at least the second user indicator device based on at least second input received from the at least the second computing device.

Example 21 includes the system of Example 20, wherein the first computing device coordinates with the at least second computing device and controls transmission of the at least the second input from the at least the second computing device to the at least the second musical instrument indicator apparatus.

Example 22 includes the system of any of Examples 20-21, wherein the at least the second computing device and the at least the second user is remotely located from the first computing device and the first user.

Example 23 includes the system of any of Examples 20-22, wherein the at least the second computing device is communicatively coupled to the first computing device at least in part using at least one of Bluetooth, Wifi, USB, Ethernet, or Internet links.

Example 24 includes the system of any of Examples 20-23, wherein the at least the second computing device is communicatively coupled to the first computing device at least in part over the Internet.

Example 25 includes the system of any of Examples 20-24, wherein the at least the second computing device is communicatively coupled to the first computing device at least in part through an intermediary server.

Example 26 includes the system of any of Examples 20-25, wherein at least one of the at least the first musical instrument indicator apparatus and the at least the second user indicator device includes at least one of: at least one visual indicator configured to visually indicate when the at least one component of the at least one musical instrument should be used by the at least one user; at least one haptic indicator configured to provide haptic indications to the at least one user when the at least one component of the at least one musical instrument should be used by the at least one user; and at least one audible indicator configured to provide audible indications to the at least one user when the at least one component of the at least one musical instrument should be used by the at least one user.

What is claimed is:

1. A musical instrument indicator apparatus for aiding at least one user in learning to play at least one musical instrument, the musical instrument indicator apparatus comprising:
at least one user indicator device configured for attachment to at least one component of the at least one musical instrument and further configured to indicate when the at least one component of the at least one musical instrument should be used by the at least one user; and
at least one controller configured to control indication from the at least one user indicator device.

2. The musical instrument indicator apparatus of claim 1, wherein the at least one controller is configured to receive input from an external computing device and to control the indication from the at least one user indicator device based on the input from the external computing device.

3. The musical instrument indicator apparatus of claim 2, wherein the external computing device is at least one of a mobile phone (including smart phones and feature phones), a tablet computer, a laptop computer, a desktop computer, an all-in-one computer, a personal data assistant, or an application device.

4. The musical instrument indicator apparatus of claim 1, wherein the at least one user indicator device includes:
at least one visual indicator configured to visually indicate when the at least one component of the at least one musical instrument should be used by the at least one user.

5. The musical instrument indicator apparatus of claim 4, wherein the at least one visual indicator includes at least one of at least one light emitting diode (LED), at least one liquid crystal display (LCD), at least one light bulb, at least one light emitting diode (LED), at least one organic light emitting diode (OLED), at least one field emission display (FED), at least one surface-conduction electron-emitter display (SED), at least one plasma display, or at least one laser light source.

6. The musical instrument indicator apparatus of claim 1, wherein the at least one user indicator device includes:
at least one haptic indicator configured to provide haptic indications to the at least one user when the at least one component of the at least one musical instrument should be used by the at least one user.

7. The musical instrument indicator apparatus of claim 1, wherein the at least one user indicator device includes: two separate user indicator devices configured for attachment with two different musical instruments.

8. The musical instrument indicator apparatus of claim 1, further configured to interface and communicate with at least a second musical instrument indicator apparatus having at least another user indicator device configured to be worn by the at least one user.

9. The musical instrument indicator apparatus of claim 8, wherein the at least the second musical instrument indicator apparatus is integrated into at least one of at least one glove or at least one strap configured to be worn by the at least one user.

10. The musical instrument indicator apparatus of claim 8, wherein the at least the second user indicator device includes at least one of:
at least one visual indicator configured to visually indicate when the at least one component of the at least one musical instrument should be used by the at least one user;
at least one haptic indicator configured to provide haptic indications to the at least one user when the at least one component of the at least one musical instrument should be used by the at least one user; and
at least one audible indicator configured to provide audible indications to the at least one user when the at least one component of the at least one musical instrument should be used by the at least one user.

11. A system for aiding at least one user in learning to play at least one musical instrument, the system comprising:
at least one computing device having a processor and memory; and
at least one musical instrument indicator apparatus for aiding at least one user in learning to play at least one musical instrument, the musical instrument indicator communicatively coupled to the at least one computing device, the musical instrument indicator apparatus comprising:
at least one user indicator device configured for attachment to at least one component of the at least one musical instrument and further configured to indicate when the at least one component of the at least one musical instrument should be used by the at least one user; and
at least one controller configured to control indication from the at least one user indicator device based on input received from the at least the first computing device.

12. The system of claim 11, wherein the at least one computing device is at least one of a mobile phone (including smart phones and feature phones), a tablet computer, a laptop computer, a desktop computer, an all-in-one computer, a personal data assistant, or an application device.

13. The system of claim 11, wherein the at least one user indicator device includes:
at least one visual indicator configured to visually indicate when the at least one component of the at least one musical instrument should be used by the at least one user.

14. The system of claim 13, wherein the at least one visual indicator includes at least one of at least one light emitting diode (LED), at least one liquid crystal display (LCD), at least one light bulb, at least one light emitting diode (LED), at least one organic light emitting diode (OLED), at least one field emission display (FED), at least one surface-conduction electron-emitter display (SED), at least one plasma display, or at least one laser light source.

15. The system of claim 11, wherein the at least one user indicator device includes:
at least one haptic indicator configured to provide haptic indications to the at least one user when the at least one component of the at least one musical instrument should be used by the at least one user.

16. The system of claim 11, wherein the at least one user indicator device includes: two separate user indicator devices configured for attachment with two different musical instruments.

17. The system of claim 11, further configured to interface and communicate with at least a second musical instrument indicator apparatus having at least another user indicator device configured to be worn by the at least one user.

18. The system of claim 17, wherein the at least the second musical instrument indicator apparatus is integrated into at least one of at least one glove or at least one strap configured to be worn by the at least one user.

19. The system of claim 17, wherein the at least the second user indicator device includes at least one of:
at least one visual indicator configured to visually indicate when the at least one component of the at least one musical instrument should be used by the at least one user;
at least one haptic indicator configured to provide haptic indications to the at least one user when the at least one component of the at least one musical instrument should be used by the at least one user; and
at least one audible indicator configured to provide audible indications to the at least one user when the at least one component of the at least one musical instrument should be used by the at least one user.

20. A system for aiding a plurality of users in learning to play musical instruments, the system comprising:
a first computing device;
at least a first musical instrument indicator apparatus communicatively coupled to the first computing device, the at least the first musical instrument indicator apparatus comprising:
at least a first user indicator device configured for attachment to at least a first component of a first musical instrument and further configured to indicate when the at least the first component of the first musical instrument should be used by a first user; and
at least a first controller configured to control indication from the at least the first user indicator device based on first input received from the first computing device;
at least a second computing device communicatively coupled to the first computing device; and
at least a second musical instrument indicator apparatus communicatively coupled to the at least the second computing device, the at least the second musical instrument indicator apparatus comprising:
at least a second user indicator device configured for attachment to at least a second component of a second musical instrument and further configured to indicate when the at least the second component of the second musical instrument should be used by a second user; and
at least a second configured to control indication from the at least the second user indicator device based on at least second input received from the at least the second computing device.

21. The system of claim 20, wherein the first computing device coordinates with the at least second computing device and controls transmission of the at least the second input from the at least the second computing device to the at least the second musical instrument indicator apparatus.

22. The system of claim 20, wherein the at least the second computing device and the at least the second user is remotely located from the first computing device and the first user.

23. The system of claim 20, wherein the at least the second computing device is communicatively coupled to the first computing device at least in part using at least one of Bluetooth, Wifi, USB, Ethernet, or Internet links.

24. The system of claim 20, wherein the at least the second computing device is communicatively coupled to the first computing device at least in part over the Internet.

25. The system of claim 20, wherein the at least the second computing device is communicatively coupled to the first computing device at least in part through an intermediary server.

26. The system of claim 20, wherein at least one of the at least the first musical instrument indicator apparatus and the at least the second user indicator device includes at least one of:
at least one visual indicator configured to visually indicate when the at least one component of the at least one musical instrument should be used by the at least one user;
at least one haptic indicator configured to provide haptic indications to the at least one user when the at least one component of the at least one musical instrument should be used by the at least one user; and
at least one audible indicator configured to provide audible indications to the at least one user when the at least one component of the at least one musical instrument should be used by the at least one user.
